(19) United States
(12) Patent Application Publication
(10) Pub. No.: US 2016/0274776 A1
(43) Pub. Date: Sep. 22, 2016

(54) SYSTEM AND METHOD FOR MODIFYING A LOOK AND FEEL OF A GRAPHICAL USER INTERFACE FOR AN APPLICATION

(71) Applicant: Cyanogen Inc., Palo Alto, CA (US)

(72) Inventor: Clark Scheff, Seattle, WA (US)

(73) Assignee: CYANOGEN INC., Palo Alto, CA (US)

(21) Appl. No.: 14/659,450

(22) Filed: Mar. 16, 2015

(51) Int. Cl. G06F 3/0484; G06T 11/60

(52) U.S. Cl. CPC G06F 3/04847; G06F 3/04842; G06T 11/60; G06T 2200/24

(57) ABSTRACT

A method and system for modifying, based on a theme, a look and feel of a graphical user interface (GUI) generated for a first application without comparably modifying a look and feel of a GUI generated for another application. The GUIs for both the first and second applications include corresponding components that are customizable. The components include icons, fonts, colors, images, sounds, and so forth. The system displays a theming overlay over the first application. The system receives an instruction from a user via the theming overlay to apply a theme to the first application. The system applies the theme to the first application and not the second application. Accordingly, a GUI element of the theme is applied to the customizable component of the first application but not the customizable component of the second application.

### BACKGROUND

Most computing devices generate visually appealing graphical user interfaces. Designers select fonts, colors, icons, and images, and similar elements, with the goal that a graphical user interface be both functional and aesthetically pleasing. However, what is beautiful to one user may be ugly to another. Designers can alleviate a user's distaste by enabling the user to customize a graphical user interface.

Some devices permit users to change the appearance of a graphical user interface in minute ways. For instance, some merely provide a choice of wallpaper or color scheme for an interface. Some graphical user interfaces can be modified by “themes,” which are packages comprising specific graphical appearance details for an application or operating system. Themes can also include sounds that replace default sounds of an application or operating system.

A user can apply a theme on a device to change the look and feel of applications and an operating system universally. However, some users may wish to only change the look and feel of an interface for a particular application. Conventional systems do not enable a user to easily customize a look and feel of a particular interface.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a system for selectively applying a theme to an application for changing a look and feel of a GUI for the application.

FIG. 2 is a block diagram of a system for selectively applying a theme to an application for changing a look and feel of a GUI for the application.

FIG. 3 is a flow diagram depicting a method, performed by a system for selectively applying a theme to an application for changing a look and feel of a GUI for the application.

FIGS. 4A-C are schematic diagrams of mobile devices showing interfaces for selectively applying a theme to an application.

### DETAILED DESCRIPTION

A method and system are described for modifying, based on a theme, a look and feel of a graphical user interface (GUI) generated for a first application without comparatively modifying a look and feel of a GUI generated for another application. The GUIs for both the first and second applications include corresponding components that are customizable. The components include icons, fonts, colors, images, sounds, and so forth. A theme comprises GUI elements, and a GUI element of a theme is associated with a component of a GUI. GUI elements comprise icons, colors, wallpapers, notification sounds, ringtones, and so forth. A GUI element is applied to a component of a GUI for changing a look and feel of the GUI when a theme that the GUI element is included in is applied to the GUI. The system applies a theme, modifying the look and feel of a GUI generated for the first application without modifying the look and feel of a GUI generated for the second application, despite the first and second applications including corresponding components that are customizable.

The system receives a request by a user to modify a look and feel of a GUI, and the system generates a theming overlay. The system receives user input navigating to a foreground application. The system receives a selection by the user of the theming overlay, and the system generates an interface for receiving a selection by a user of a theme to apply to the foreground application. The system receives a selection by the user of a theme to apply to the foreground application. The system modifies, based on the selected theme, the look and feel of a GUI generated for the foreground application. The system does not modify, based on the selected theme, the look and feel of a GUI generated for another application.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of systems for theming a first application without similarly theming a second application. The systems are described with respect to a number of processes that they may implement and numerous examples of how they may be implemented.

### Suitable Environments

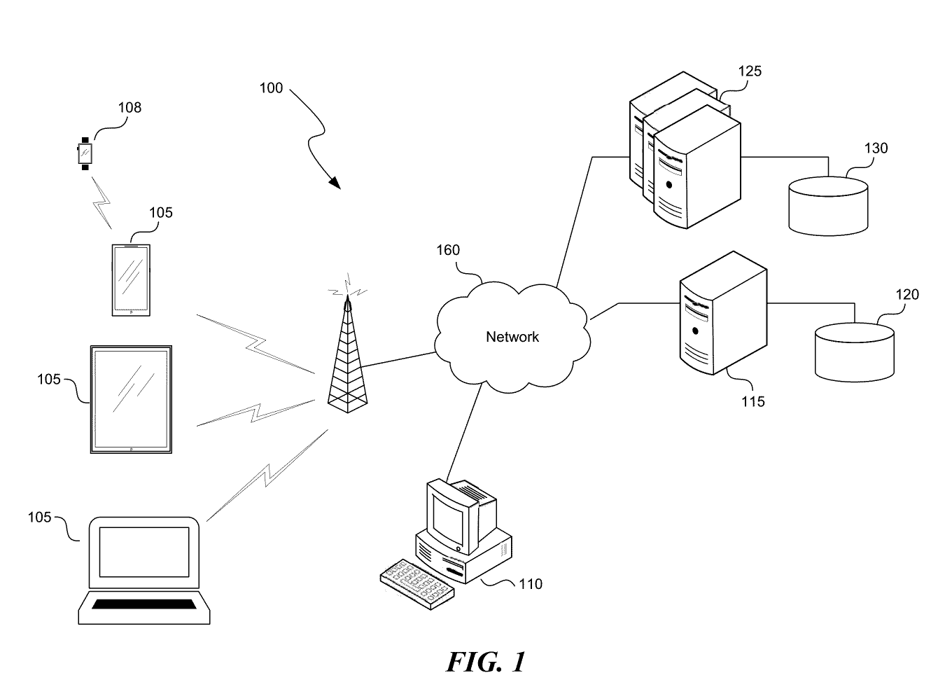

FIG. 1 and the following discussion provide a brief, general description of a suitable computing environment 100 in which a system for selectively applying a theme to an application can be implemented. Although not required, aspects and implementations of the invention will be described in the general context of computer-executable instructions, such as routines executed by a general-purpose computer, a personal computer, a mobile device, a server, or other computing systems. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system for selectively applying a theme to an application for changing a look and feel of a GUI for the application, according to embodiments of the invention, operates in or among mobile devices 105, wearable devices 108, personal computers 110, and one or more server computers 115. The mobile devices 105, wearable devices 108, and personal computers 110 communicate through one or more wired or wireless networks 160 with the server 115. A data storage area 120 contains data utilized by the system, and, in some implementations, software necessary to perform functions of the system. For example, the data storage area 120 may contain GUI data, such as data describing customizable components of a GUI for an application. Devices 105, 108, 110 can store themes in the data storage area 120. The system for applying a general theme to a first application and not a second application communicates via public or private networks with one or more third party servers 125 storing data in data storage area 130. The third party servers include servers maintained by entities that host third party themes.

The mobile devices 105 and computers 110 communicate with each other and the server 115 and third party servers 125 through networks 160, including, for example, the Internet. The mobile devices 105 communicates wirelessly with a base station or access point using a wireless mobile telephone standard, such as the Global System for Mobile Communications (GSM), or another wireless standard, such as IEEE 802.11, and the base station or access point communicates with the server 115 via the networks 160. Computers 110 communicate through the networks 160 using, for example, TCP/IP protocols. The wearable devices 108 communicate via short range communication protocols (e.g., Bluetooth) with the mobile devices 105 and/or computers 110.

### Suitable Systems

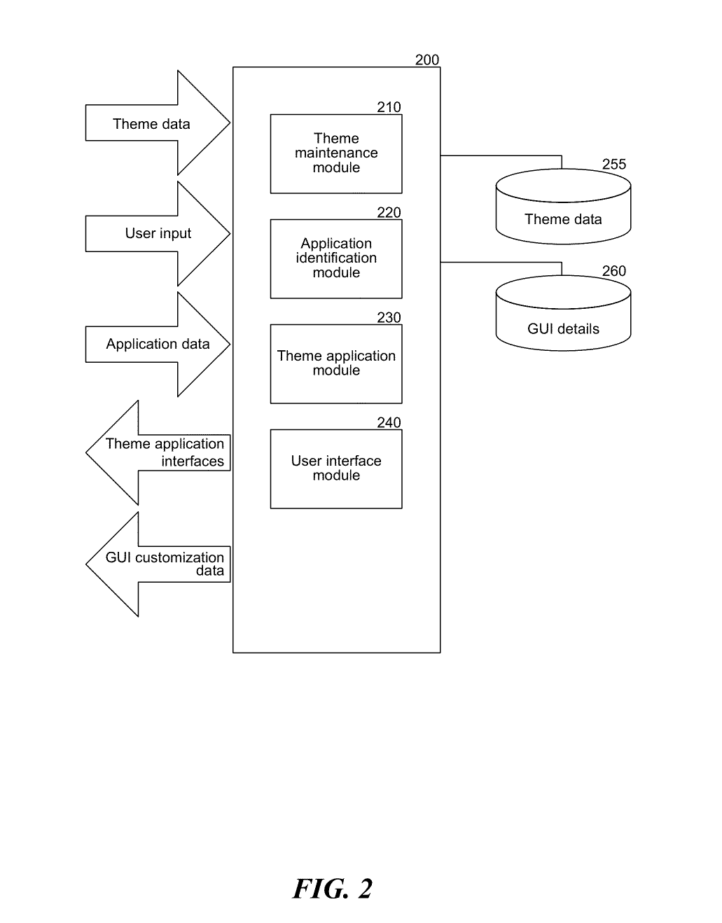

FIG. 2 is a block diagram of a system 200 for selectively applying a theme to a first application, and not a second application, for changing a look and feel of a GUI for the first application. Although the theme may be applied generally across GUIs for many different applications, the system applies the theme specifically to the selected application. In some implementations, the selected application is a foreground application of a GUI. The system can operate in, for example, mobile devices 105, wearable device 108, and/or computers 110, or distributed among at least one device and server 115, for selectively applying a theme to an application operating on one of these devices. The system 200 includes a theme maintenance module 210, an application identification module 220, a theme application module 230, and a user interface module. The system receives theme data, user input, and application data, and outputs theme application interfaces and GUI customization data. The system stores data in and reads data from theme data storage 255 and GUI details data storage 260.

The theme maintenance module 210 maintains theme data in theme data storage area 255. Theme data includes themes, GUI elements, and data associated with themes or GUI elements. Themes are packages of GUI elements. GUI elements include icons, fonts, colors, images, wallpapers, controls, ringtones, boot animations, notification sounds, etc. A GUI element of a theme is associated with at least one component of a GUI, and the GUI element is applied to the at least one component of the GUI when the theme is applied to the GUI. Components of a GUI include icons, fonts, colors, wallpapers, etc. of a GUI. A component can include sub-components. For example, an icons component may include sub-components for individual icons. The system can treat sub-components as it does components. For example, a GUI element of a theme can be associated with a sub-component of a GUI, and the GUI element can be applied to the sub-component when the theme is applied to a GUI for an application.

Theme data is stored in theme data storage 255. In some implementations, theme data is received from third parties. For example, the system may receive a theme from a theme publisher. Theme data can also be created by a user of a device whose GUI is customized by the system, or theme data may be created by other users. For example, theme data may include a customized theme, as described in commonly-assigned U.S. patent application Ser. No. 14/519,156, filed Oct. 21, 2014, entitled SYSTEM AND METHOD FOR CUSTOMIZING A THEME FOR MODIFYING A LOOK AND FEEL OF A GRAPHICAL USER ITERFACE, which is incorporated in its entirety by reference herein. In some implementations, theme data stored in theme data storage 255 includes themes of a theme store, and the themes can be purchased by a user. In some implementations, theme data includes settings and configuration details for a GUI generated by a device. For example, theme data may include a theme that has already been applied to a GUI for an operating system.

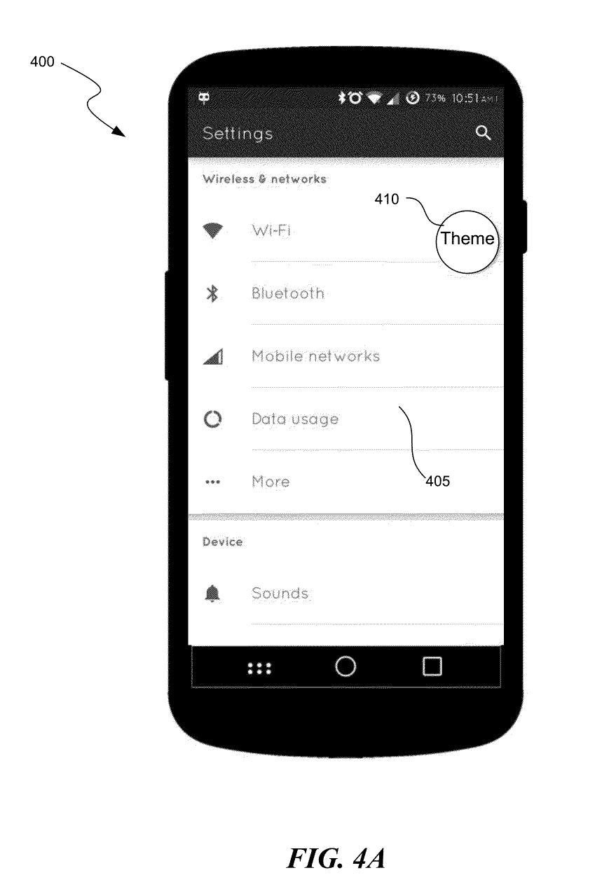

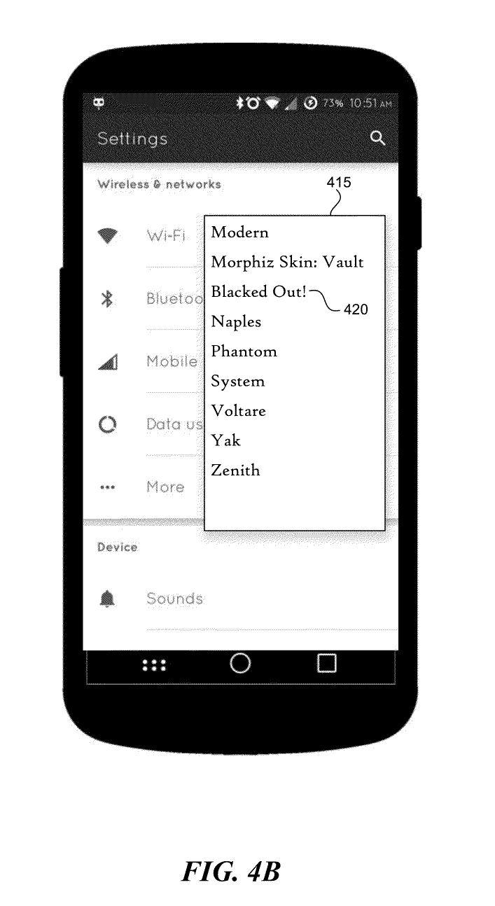

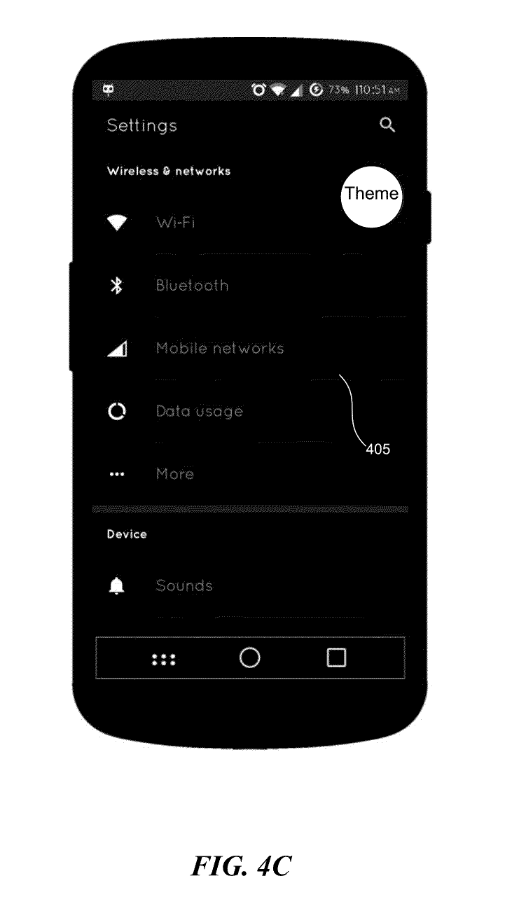

The application identification module 220 receives application data and identifies an application that a theme is to be applied to. Application data includes information associated with active applications running on a device, including an application name. Application data includes customizable components of GUI generated for an application. In some implementations, the application identification module receives a selection by a user of an application that a theme is to be applied to. For example, the user interface module 240 may generate an interface including a list of applications, and the system may receive a user's selection of an application from the list. In some implementations, the application identification module identifies an application that a theme is to be applied to based on a foreground application in a GUI being displayed by a device when a request to theme an application is received from the user. For example, the application identification module may identify the application that is to be themed based on the foreground application in a GUI when a selection of a theming overlay is received. FIG. 4A is a schematic drawing of a mobile device 400 showing a GUI 405 for a Settings application, including a theme button 410 of a floating window displayed in the GUI 405. The theme button of the floating window is a theming overlay. If the theme button is selected while it is over the foreground Settings application, the application identification module identifies the foreground Settings application as the application to be themed. In some implementations, the application identification module 220 identifies the foreground application from among active processes running on a device, identified in received application data. For example, a device may include an activity manager, which is an application that maintains a list of tasks/applications that are running on the device. The activity manager may include a function that returns a list of active tasks, and a task/application included in the list is the foreground task. In some implementations, the application identification module 220 requests that the activity manager produce a list of active tasks, and a first task on a list returned by the activity manager is a task corresponding to a foreground application. Information provided by the activity manager may include a package name for an application corresponding to the foreground task. The application identification module provides the application data, including information identifying the foreground application, to the theme application module 230. The application identification module may store data related to a GUI generated for an application, including customizable components of the application, in GUI details data storage 260.

The theme application module 230 receives user input including an instruction to apply a theme to an application, and generates GUI customization data that is applied to data for generating a GUI for the application, thus applying the theme to the application. Theme data can be accessed in theme data storage area 255. The theme application module may receive a selection by a user of a theme to apply to the application. For example, after receiving a selection of the theme button 405 included in the GUI 405 of FIG. 4A, the system may generate an interface including a list of themes that can be applied to the application. FIG. 4B shows the mobile device 400 having a GUI that includes a themes menu 415. The system may receive a selection by the user of a theme from the themes menu, and apply the selected theme to the foreground application.

GUI customization data includes configuration details, determined based on the identified theme, for modifying a look and feel of a GUI generated for an application. GUI customization data can identify or include GUI elements of a theme, which are respectively associated with customizable components of a GUI generated for an application, which may be included in application data. The theme application module 230 can apply a theme to an application by outputting an instruction to modify, based on GUI customization data for the theme, data used for generating a GUI for the application, such that customizable components of the GUI for the application are associated with GUI elements of the theme.

In some implementations, data for generating a GUI for an application is stored in a database using the JavaScript Object Notation (JSON) format. The JSON formatted data is represented as a string in the database. In some implementations, the theme application module 230 applies a theme to an application by modifying, based on GUI customization data, the JSON formatted data for generating a GUI for the application. When booting into an operating system or launching an application, a device references the JSON formatted data to identify GUI elements to load, reflecting the theme applied to the application.

In some implementations, GUI customization data includes a resource table listing GUI elements of a theme and a command that a device reference the resource table for identifying GUI elements when generating a GUI for a themed application. In some implementations, GUI customization data includes additions or changes to an existing resource table including GUI elements of a theme. For example, a theme may already be applied generally on a device, and GUI customization data may add references to GUI elements of a theme being applied for customizable components of a GUI generated for a foreground application. The operating system can traverse through multiple resource tables in order to identify GUI elements to apply to components of a GUI generated for the application, and it can utilize framework and application resources for identifying GUI elements to apply to components not modified by the resource tables. GUI customization data can also include XML data identifying GUI elements for an application being themed. For example, XML data can identify a font to be applied as part of a theme to an application.

The user interface module 240 generates theme application interfaces, including various graphical user interfaces for displaying information to a user and receiving user input. For example, the user interface module generates a theming overlay, which may be displayed over a GUI for a foreground application, as discussed above. The user interface module 240 may generate the theming overlay after receiving a selection by a user of an application for selectively theming an application. In some implementations, the theming overlay is a floating window. The system may receive a user's selection of the them ing overlay for identifying an application to be themed. The user interface module generates the interfaces included in FIGS. 4A-C.

### Example Processes

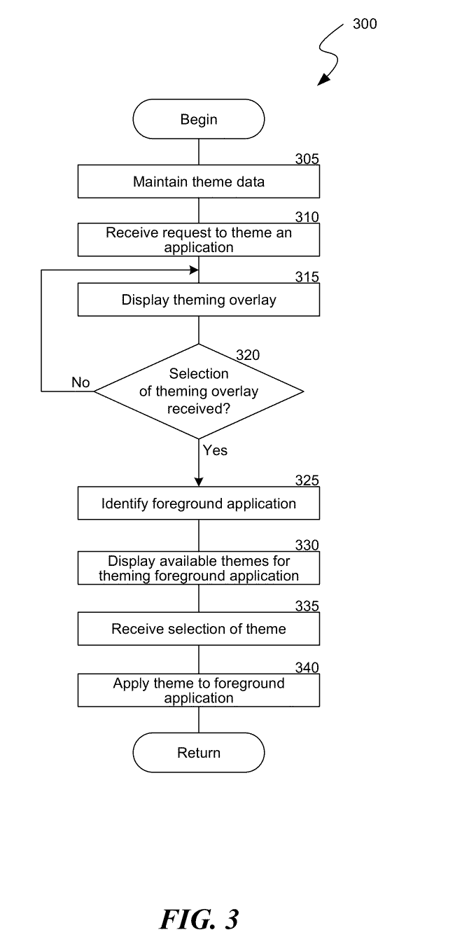

The system 200 for selectively applying a theme to an application for changing a look and feel of a GUI for the application may operate on a mobile device. FIG. 3 is a flow diagram representing a process 300 performed by the system 200 for modifying a look and feel of a GUI for an application, generated by a mobile device. In some implementations, the process 300 is performed for modifying a GUI for a foreground application already being generated by a device, and a look and feel for the GUI of the foreground application is changed in real-time after receiving an instruction from a user to apply a theme to the application. In some implementations, a theme has already been applied to a foreground application that is being themed, and the system applies a new theme to the foreground application but not to other applications that were previously themed with the foreground application. For example, an application being themed may have already been themed as part of a general theming process for a device.

At a block 305, the system 200 maintains theme data, including themes and GUI elements. Themes may be maintained by storing theme data on the mobile device or in remote data storage. In some implementations, the system receives theme data that is maintained by another system. For example, theme data may be downloaded from a theme store operated by third party systems. At a block 310, the system 200 receives a request to apply a theme to an application. In some implementations, the system receives an instruction by a user to launch an application for theming applications.

At a block 315, the system 200 displays a theming overlay. The system identifies an application to be themed based on the foreground application on which the theming overlay appears when the theming overlay is selected by a user. A user may navigate between applications or to a home screen, and the theming overlay remains displayed over the active foreground application. Similarly, a user may interact with a device, including a foreground application and GUI elements of the foreground application, while the theming overlay is displayed over an interface. For example, referring again to FIG. 4A, the theme button 410 appears over the GUI 405 for the Settings application, and if a user were to navigate away from the Settings application to, for example, a dialer application, the theme button 410 would remain on the GUI being generated by the device and appear over a GUI for the dialer application. In some implementations, the system receives user input moving the theming overlay on the display, such as via a drag and drop gesture.

At a decision block 320, the system determines whether a selection has been received of the theming overlay. A selection of the theming overlay corresponds to a request by a user to identify a theme to apply to a foreground application displayed in a GUI below the theme button. For example, referring again to FIG. 4A, the system may receive a selection of the theme button 410. If the system determines that no selection has been received of the theming overlay, the process returns to block 315, and the system continues to display the theming overlay. In some implementations, the system stops displaying the theming overlay after not receiving a selection of the theming overlay. For example, the system may receive an instruction from the user to stop displaying the theming overlay. The instruction can be received via a gesture. For example, the system may determine to not display the theming overlay after receiving touch input from a user of a drag and drop motion associated with closing the theming overlay. The system may receive a selection of the theming overlay in various ways. In some implementations, the system receives a selection via a tap on the theming overlay received via a touch panel of a mobile device. If the system receives a selection of the theming overlay, the process 300 proceeds to a block 325.

At block 325, the system 300 identifies a foreground application associated with the selection of the theming overlay. The foreground application is associated with a GUI displayed below the theming overlay when the selection from the user was received. For example, the foreground application associated with the GUI 405 of the mobile device 400 of FIG. 4 is a Settings application. In some implementations, identifying a foreground application includes identifying an application package associated with the foreground application.

At a block 330, the system 300 displays available themes for theming the foreground application. In some implementations, the system generates a menu listing themes that can be applied to the foreground application. For example, FIG. 4B shows the mobile device 400 showing a GUI that includes the themes menu 415 generated after receiving a selection by a user of the theme button 410. The theme menu 415 lists the names of various themes that can be applied to the Settings application. In some implementations, the system displays themes that are identified as being available to be applied generally to a GUI for the mobile device. For example, the displayed themes may include general themes available from a theme store operated by a third party.

At a block 335, the system 300 receives a selection of a theme to apply to the foreground application. For example, referring again to FIG. 4B, the system may receive a selection of a theme, such as a theme 420 called “Blacked Out!” via the menu 415. At a block 440, the system applies the selected theme to the foreground application. The system can apply the theme to the foreground application by specifying in configurations and settings data that the theme be used when a GUI is being generated for the foreground application. The system may modify the data used for generating a GUI for the foreground application, including by causing a customizable component of the GUI generated for the foreground application to be associated with a GUI element of the selected theme. Thus, when a GUI is generated for the foreground application, it is generated using the selected theme and the GUI element. For example, FIG. 4C shows the GUI 405 for the settings application with the Blacked Out! theme applied. The system may change the theme of a foreground application in real-time, allowing a user to instantly view the changes to a look and feel of an application after a theme is applied. In some implementations, the system causes the foreground application to refresh its GUI, causing the foreground application to display GUI elements of the theme applied to the foreground application. When applying the selected theme to the foreground application, the system does not apply the selected theme to another application different from the foreground application, even though the theme may be applied generally to GUIs for different applications generated by a device.

The disclosed system and method enable a user to quickly and easily apply a theme to an application without applying the theme to other applications. A user may quickly theme different applications based on different themes. Accordingly, a user is provided more control over the look and feel of applications on a device.

### CONCLUSION

Those skilled in the art will appreciate that the actual implementation of a data storage area may take a variety of forms, and the phrases “data storage” and “data storage area” are used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A non-transitory computer-readable storage medium containing instructions for causing a device to perform a method for modifying a look and feel of a graphical user interface (GUI) for a foreground application operating on the device, the method comprising:
receiving a request by a user to modify a look and feel of an application operating on a device;
displaying a theming overlay via a display of the device,
wherein the theming overlay is displayed over a foreground application displayed by the device
wherein the foreground application includes a customizable component, and
wherein the foreground application includes a first GUI element applied to the customizable component,
receiving a selection by the user of the theming overlay;
identifying the foreground application displayed by the device;
displaying an indication of a theme,
wherein the theme includes a second GUI element,
wherein the second GUI element is associated with the customizable component of the foreground application, and
wherein the second GUI element is to be applied to the customizable component of the foreground application when the theme is applied to the foreground application;
receiving a selection by the user of the indication of the theme; and
applying the theme to the to the foreground application,
wherein the second GUI element is applied to the customizable component of the foreground application.

2. The non-transitory computer-readable storage medium of claim 1, wherein an application that is not the foreground application of the GUI also includes the customizable component, and wherein the second GUI element is not applied to the customizable component of the application that is not the foreground application of the GUI in response to receiving the selection by the user of the indication of the theme.

3. The non-transitory computer-readable storage medium of claim 1, wherein the first GUI element applied to the customizable component is a GUI element included in a theme different from the theme applied to the foreground application.

4. The non-transitory computer-readable storage medium of claim 1, the method further comprises:
identifying an application package associated with the foreground application of the GUI, and
modifying data for generating a GUI associated with the application package to include a reference to the theme being applied to the foreground application.

5. The non-transitory computer-readable storage medium of claim 1, further comprising refreshing the GUI for the foreground application upon applying the theme to the foreground application, wherein refreshing the GUI for the foreground application includes generating the GUI based at least in part on the second GUI element being applied to the customizable component of the foreground application.

6. The non-transitory computer-readable storage medium of claim 1, wherein the first GUI element includes an icon, a font, a color, or a wallpaper.

7. The non-transitory computer-readable storage medium of claim 1, wherein the theme is configured to be applied generally to other applications in addition to the foreground application.

8. A method of modifying a look and feel of a graphical user interface (GUI) for a foreground application operating on a device, the method implemented by a processor executing instructions stored in a memory, the method comprising:
receiving a request by a user to modify a look and feel of an application operating on a device;
displaying a theming overlay via a display of the device,
wherein the theming overlay is displayed over a foreground application displayed by the device
wherein the foreground application includes a customizable component, and
wherein the foreground application includes a first GUI element applied to the customizable component,
receiving a selection by the user of the theming overlay;
identifying the foreground application displayed by the device;
displaying an indication of a theme,
wherein the theme includes a second GUI element,
wherein the second GUI element is associated with the customizable component of the foreground application, and
wherein the second GUI element is to be applied to the customizable component of the foreground application when the theme is applied to the foreground application;
receiving a selection by the user of the indication of the theme; and
applying the theme to the to the foreground application, wherein the second GUI element is applied to the customizable component of the foreground application.

9. The method claim 8, wherein an application that is not the foreground application of the GUI also includes the customizable component, and wherein the second GUI element is not applied to the customizable component of the application that is not the foreground application of the GUI in response to receiving the selection by the user of the indication of the theme.

10. The method of claim 8, wherein the first GUI element applied to the customizable component is a GUI element included in a theme different from the theme applied to the foreground application.

11. The method of claim 8, wherein the method further comprises:
identifying an application package associated with the foreground application of the GUI, and
modifying data for generating a GUI associated with the application package to include a reference to the theme being applied to the foreground application.

12. The method of claim 8, further comprising refreshing the GUI for the foreground application upon applying the theme to the foreground application, wherein refreshing the GUI for the foreground application includes generating the GUI based at least in part on the second GUI element being applied to the customizable component of the foreground application.

13. The method of claim 8, wherein the first GUI element includes an icon, a font, a color, or a wallpaper.

14. The method of claim 8, wherein the theme is configured to be applied generally to other applications in addition to the foreground application.

15. A system for modifying a look and feel of a graphical user interface (GUI) for a foreground application operating on a device, the system comprising:
a memory storing computer-executable instructions of:
a user interface module configured to:
receive a request by a user to modify a look and feel of an application operating on a device;
display a theming overlay via a display component of the device,
wherein the theming overlay is displayed over a foreground application displayed via the display component of the device;
wherein the foreground application includes a customizable component, and
wherein the foreground application includes a first GUI element applied to the customizable component,
receive a selection by the user of the theming overlay;
display an indication of a theme, and
receive a selection by the user of the indication of the theme for applying the theme to the foreground application; and
a theme maintenance module configured to:
identify a theme upon receiving a selection by the user of the theming overlay,
wherein the theme includes a second GUI element,
wherein the second GUI element is associated with the customizable component of the foreground application, and
wherein the second GUI element is to be applied to the customizable component of the foreground application when the theme is applied to the foreground application;
an application identification module configured to:
identify the foreground application displayed by the device when the selection by the user of the theming overlay is received; and
a theme application module configured to:
apply the theme to the to the foreground application,
wherein the second GUI element is applied to the customizable component of the foreground application; and
a processor for executing the computer-executable instructions stored in the memory.

16. The system claim 15, wherein an application that is not the foreground application of the GUI also includes the customizable component, and wherein the second GUI element is not applied to the customizable component of the application that is not the foreground application of the GUI in response to receiving the selection by the user of the indication of the theme.

17. The system of claim 15, wherein the first GUI element applied to the customizable component is a GUI element included in a theme different from the theme applied to the foreground application.

18. The system of claim 15, wherein the theme application module is further configured to:
identify an application package associated with the foreground application of the GUI, and
modify data for generating a GUI associated with the application package to include a reference to the theme being applied to the foreground application.

19. The system of claim 15, wherein the theme application module is further configured to cause the device to refresh the GUI for the foreground application upon the theme being applied to the foreground application, wherein causing the GUI for the foreground application to refresh includes causing the GUI to be generated including the second GUI element applied to the customizable component of the foreground application.

20. The system of claim 15, wherein the first GUI element includes an icon, a font, a color, or a wallpaper.
